(19) United States
(12) Patent Application Publication
(10) Pub. No.: US 2007/0091430 A1
(43) Pub. Date: Apr. 26, 2007

(54) REAR PROJECTION DISPLAY

(75) Inventors: Kuo-Yuan Chang, Hsinchu (TW); Wei-Cheng Huang, Hsinchu (TW)

Correspondence Address: J C PATENTS, INC., 4 VENTURE, SUITE 250, IRVINE, CA, 92618, US

(73) Assignee: CORETRONIC CORPORATION, Hsinchu (TW)

(21) Appl. No.: 11/532,430

(22) Filed: Sep. 15, 2006

(30) Foreign Application Priority Data
Oct. 21, 2005 (TW) 94218223

(51) Int. Cl. G03B 31/00; G03B 21/22; G03B 21/56

(52) U.S. Cl. 359/443; 353/18

(57) ABSTRACT

A rear projection display including a display unit, a plurality of guiders, a display screen, and at least one fastener is provided. The guiders are disposed on two opposite sides of the display unit respectively, and each guider has a guiding groove protruding from the display unit. The display screen is disposed between the guiders, and the display screen slides along the guiding grooves. The fastener which covers a portion of the display screen is disposed on the display unit. The display screen is fastened on the display unit by the guiders and the fastener.

### CROSS-REFERENCE TO RELATED APPLICATION

This application claims the priority benefit of Taiwan application serial no. 94218223, filed on Oct. 21, 2005. All disclosure of the Taiwan application is incorporated herein by reference.

### BACKGROUND OF THE INVENTION

1. Field of Invention

The present invention relates to a display. More particularly, the present invention relates to a rear projection display.

2. Description of Related Art

With the significant improvement of the performance of the computer, and the high development of internet and multimedia techniques, at present image information is usually transmitted in digital form instead of analog form. To satisfy the demands of modern life, video and image devices have gradually become much lighter and thinner. Thus, the recently developed flat panel display (FPD), such as the liquid crystal display (LCD), organic electro-luminescent display (OELD), rear projection display, and plasma display panel (PDP), has gradually become the main display product of the market.

Referring to FIG. 1, it is a schematic view of a conventional rear projection display. The rear projection display 10 comprises a display unit 11, a display screen 12, and a base 13. The display unit 11 is disposed on the base 13. An optical engine, a projection lens and the like (not shown) are installed within the base 13 for projecting images. The display screen 12 is disposed on the display unit 11, and the optical engine and the projection lens project the images onto the display screen 12. Additionally, for the purpose of improving the audio-visual effect, a speaker (not shown) is disposed on the base 13 or the display unit 11 optionally to output the sound signals.

Referring to FIG. 2, it is a schematic view of the display screen and a fixing frame of the conventional rear projection display. When the display screen 12 needs to be assembled with the rear projection display 10, conventionally the display screen 12 is disposed on the display unit 11, and then locked onto the display unit 11 by screws 15 and the fixing frame 14. Similarly, when the rear projection display 10 needs to be repaired, or internal parts need to be replaced, or the inside of the display unit 11 needs to be cleaned, a user detaches the screws 15 from the fixing frame 14, and then holds the display screen 12 carefully to prevent it from falling down and being damaged. After the screws 15 have been detached, the fixing frame 14 is removed and then the display screen 12 is taken out and repaired, and replacement of internal parts of the inside of the display unit 11, or cleaning of the inside of the display unit 11 is proceeds. In other words, it is inconvenient to assemble and detach the display screen 12, and the required working time is long.

### SUMMARY OF THE INVENTION

In view of the above, an object of the present invention is to provide a rear projection display, for which the required working time of assembling and detaching the display screen is reduced.

To achieve the above or other objects, a rear projection display which comprises a display unit, guiders, a display screen, and at least one fastener is provided. The guiders are disposed on the two opposite sides of the display unit respectively, and each of the guiders has a guiding groove. The display screen is disposed between the guiders, and slides along the guiding grooves. The fastener is disposed on the display unit and covers a part of the display screen. The display screen is fixed on the display unit by the guiders and the fastener.

In a preferred embodiment of the present invention, the display unit has a base and a plurality of audio output modules. The audio output modules are disposed on the base and located on the two opposite sides of the display screen.

In a preferred embodiment of the present invention, the guiding grooves protrudes from the audio output modules.

In a preferred embodiment of the present invention, the fastener is disposed on one of the audio output modules.

In a preferred embodiment of the present invention, the guiders is located at the upper and lower sides of the display screen, and the fastener is located at the left or right side of the display screen.

In a preferred embodiment of the present invention, each fastener comprises a main body and screws, and the screws are disposed on the main body, so as to fix the main body on the display unit.

As described above, the display screen is fastened onto the display unit by the fastener and the guiders according to the rear projection display of the present invention. The display screen slides along the guiders. Therefore, as the display screen needs to be detached, only the fastener is required to be detached so as to remove the display screen. In other words, the rear projection display of the present invention has advantages including that the internal parts are cleaned and repaired quickly, and the working time of assembling and detaching is reduced.

In order to the make the aforementioned and other objects, features and advantages of the present invention comprehensible, the preferred embodiments accompanied with drawings are described in detail below.

### BRIEF DESCRIPTION OF THE DRAWINGS

FIG. 1 is a schematic view of a conventional rear projection display.

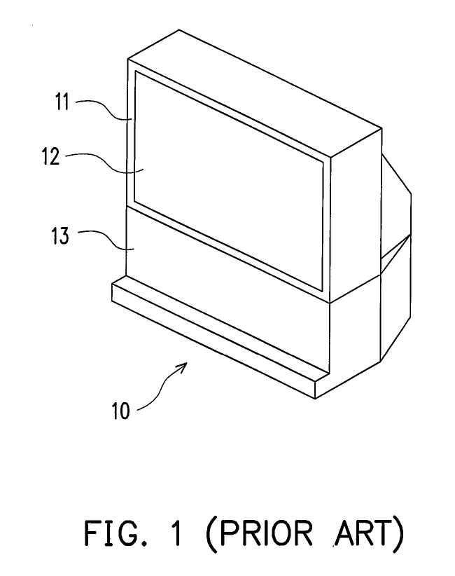

FIG. 2 is a schematic view of a display screen and a fixing frame of the conventional rear projection display.

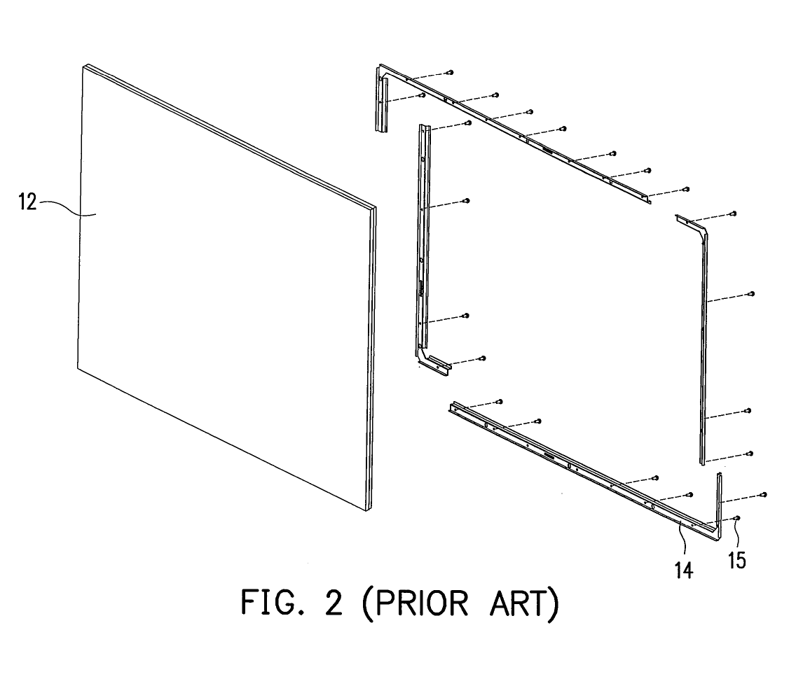

FIG. 3A is a front view of the rear projection display according to an embodiment of the present invention.

FIG. 3B is a side view of a rear projection display according to the embodiment of the present invention.

FIG. 4 is a perspective view of a guider according to the embodiment of the present invention.

### DESCRIPTION OF PREFERRED EMBODIMENTS

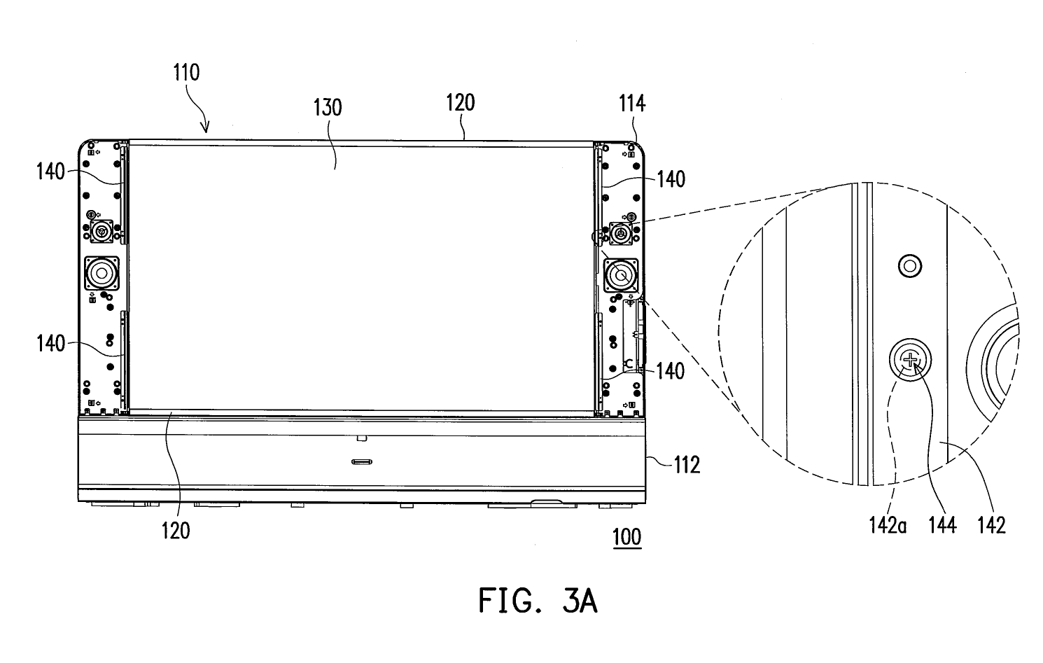

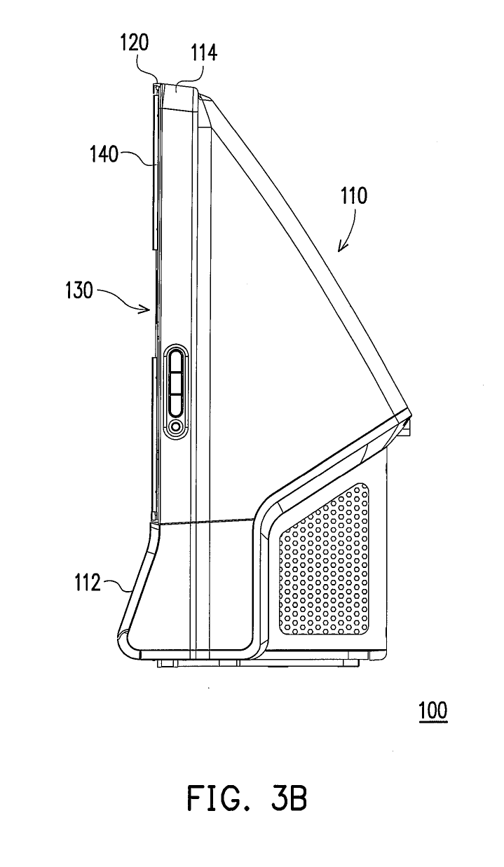

Referring to FIGS. 3A and 3B, FIG. 3A is a front view of a rear projection display according to an embodiment of the present invention, and FIG. 3B is a side view of the rear projection display according to the embodiment of the present invention. A rear projection display 100 comprises a display unit 110, a plurality of guiders 120, a display screen 130, and at least one fastener 140. The display unit 110 has a base 112 and a plurality of audio output modules 114, wherein the audio output modules 114, for example, speakers, are disposed on the base 112 and on the two opposite sides of the display screen 130. However, the display unit 110 is not limited to having the audio output modules 114. In addition, the base 112 is provided with optical elements, such as an optical engine and a projection lens (not shown), to project images.

The guiders 120 are disposed on the two opposite sides of the display unit 110 respectively, and the fasteners 140 are disposed on the two opposite sides of the display screen 130 respectively. Each guider 120 and each fastener 140 cover a part of the display screen 130 respectively, so as to fasten the display screen 130 on the display unit 110. In other words, the guiders 120 and the fasteners 140 are used for fastening the four sides of the display screen 130. However, the embodiment does not limit the location, type, and number of the guiders 120 and the fasteners 140. For example, when one end of each guider 120 is connected to form a U shape, only one fastener 140 is required. In addition, the guiders 120 can also be disposed on the left and right sides of the display screen 130, and the fasteners 140 can also be disposed on the upper and lower sides of the display screen 130.

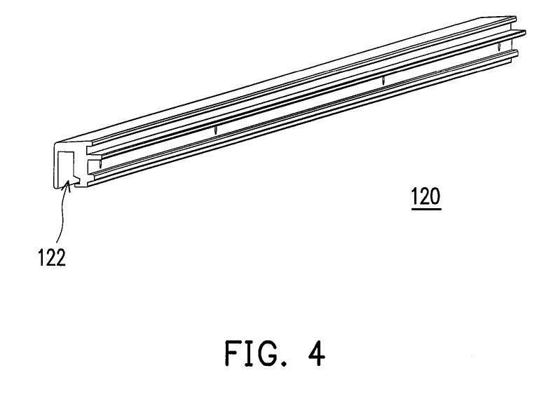

Referring to FIGS. 3B and 4, FIG. 4 is a perspective view of a guider according to the embodiment of the present invention. Each guider 120 has a guiding groove 122 protruding from the audio output module 114, and the display screen 130 is disposed in the guiding grooves 122. In addition, the guiders 120 can be made of reinforced plastic, aluminum alloys, or other metals or alloys. Furthermore, when the guiders 120 are made of aluminum alloys, they can be formed by extrusion molding. Since the display screen 130 slides along the guiding grooves 122, a film (not shown) can also be disposed in the guiding grooves 122, so as to reduce the friction force. Additionally, in this embodiment, two guiders 120 are used for guiding the display screen 130 so as to facilitate the assembly. However, the present invention does not limit the number of the guiders. In other words, two or more guiders 120 can be used for guiding the display screen 130.

Referring to FIG. 3A again, each fastener 140 comprises a main body 142 and a plurality of screws 144. The main body 142 has mounting holes 142a thereon, and the screws 144 are disposed in the mounting holes 142a, so as to fix the main body 142 onto the audio output module 114. The fasteners 140 are made of metals, alloys, or reinforced plastic. After the display screen 130 slides into the guiders 120, the fasteners 140 are used to fix the display screen 130, so as to avoid the displacement of the display screen 130.

Referring to FIGS. 3A and 4, the steps of assembling the rear projection display 100 of the present invention are described as follows. Firstly, the guiders 120 are fixed on the display unit 110. Then the display screen 130 is accommodated in the guiding grooves 122 of the guiders 120, and is forced to slide along the guiding grooves 122 to the position. Additionally, when the display screen 130 slides along the guiding grooves 122, since the guiding grooves 122 protrudes from the audio output modules 114, the display screen 130 does not hit the audio output module 114.

Then, the display screen 130 is fixed on the display unit 110 by the fasteners 140. In this embodiment, the main body 142 of each fastener 140 covers a part of the display screen 130, and then all main body 142 are locked on the audio output modules 114 by screws 144. Thus, the display screen 130 is fastened on the display unit 110 by the guiders 120 and the fasteners 140. Finally, a cover plate (not shown) is disposed on the audio output module 114, so that the assembling of the rear projection display 100 is completed. Definitely, the process of detaching the display screen 130 from the display unit 110 is achieved by carrying out the above steps conversely.

In this embodiment, a buffer pad (not shown) can also be disposed between the display screen 130 and the fastener 140. The material of the buffer pad can be rubber. The buffer pad can be used to provide a good fastening effect between the fasteners 140 and the display screen 130, and also prevent the display screen 130 sliding slightly. Furthermore, as for the case that the display unit 110 is provided with the audio output modules 114, since the audio output modules 114 output middle and low frequency sound, resulting in the vibrating of the display screen 130, the buffer pad can be used to reduce the vibrating of the display screen 130 so as to reduce the noise. Furthermore, when the display screen 130 expands or shrinks due to the changing of temperature, the buffer pad can be used to reduce the probability of being damaged by the expansion and shrink. Furthermore, the buffer pad can be used to prevent dust from entering the display unit 110 through the slit between the fasteners 140 and the display screen 130.

Since the guiders 120 are disposed on the display unit 110, and the display screen 130 slides along the guiding grooves 132, after the display screen 130 is disposed in the guiding grooves 132, it is unnecessary for the user to hold the display screen 130, thus increasing the convenience of assembling. Additionally, when detaching the display screen 130, only the fasteners 140 are required to be detached, so that the display screen 130 is directly taken out from the guiding grooves 132. Compared with the conventional art in which the fixing frame has to be detached before removing the display screen, in the present invention, only the fasteners 140 are required to be detached for the display screen to be removed. Therefore, the working time of assembling and detaching the display screen 130 is reduced, and the replacement of internal parts or the cleaning of the inside of the display is achieved quickly. In addition, since the base 112 and the audio output modules 114 can be formed integrally, the overall structure strength of the rear projection display 100 can also be improved. Furthermore, compared with the conventional art, space is saved according to the present invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A rear projection display, comprising:
a display unit;
a plurality of guiders disposed on the two opposite sides of the display unit, each of the guiders having a guiding groove;
a display screen disposed between the guiders and adapted to be sliding along the guiding grooves; and
at least one fastener disposed on the display unit, wherein the fastener covers a portion of the display screen, and the display screen is fixed on the display unit by the guiders and the fastener.

2. The rear projection display as claimed in claim 1, wherein the display unit has a base and a plurality of audio output modules, and the audio output modules are disposed on the base and located on the two opposite sides of the display screen.

3. The rear projection display as claimed in claim 2, wherein the guiding grooves are protruding from the audio output modules.

4. The rear projection display as claimed in claim 1, wherein the guiders are located on the upper and lower sides of the display screen respectively, and the fastener is located on the left or right side of the display screen.

5. The rear projection display as claimed in claim 1, further comprising a film disposed on the surface of the guider contacting the display screen for reducing the friction force.

6. The rear projection display as claimed in claim 1, wherein the fastener comprises:
a main body; and
a plurality of screws disposed on the main body for fixing the main body on the display unit.
